(19) United States
(12) Patent Application Publication
(10) Pub. No.: US 2011/0192698 A1
(43) Pub. Date: Aug. 11, 2011

(54) VEHICLE COUPLING

(75) Inventors: Hiroyuki Shimokasa, Toyota-shi (JP); Hideki Tamoto, Toyota-shi (JP); Isao Kozawa, Toyota-shi (JP)

(73) Assignee: Toyota Jidosha Kabushiki Kaisha, Toyota-Shi (JP)

(21) Appl. No.: 13/021,961

(22) Filed: Feb. 7, 2011

(30) Foreign Application Priority Data
Feb. 5, 2010 (JP) JP2010-024880

(51) Int. Cl. F16D 25/0638; F16D 13/52; F16D 48/06

(52) U.S. Cl. 192/70.11

(57) ABSTRACT

A vehicle coupling includes a wet type multiple disc clutch that selectively connects or disconnects a driving member to or from a driven member; a piston that engages the wet type multiple disc clutch by pushing against the wet type multiple disc clutch in an axial direction; a pushing mechanism that generates force with which the piston pushes against the wet type multiple disc clutch, based on the relative torque between the driving member and the driven member; and a hydraulic mechanism that generates hydraulic pressure for generating thrust to move the piston away from the wet type multiple disc clutch, according to differential rotation between the driving member and the driven member when the wet type multiple disc clutch is released.

### CROSS-REFERENCE TO RELATED APPLICATIONS

This application claims priority to Japanese Patent Application No. 2010-024880 filed on Feb. 5, 2010, which is incorporated herein by reference in its entirety including the specification, drawings and abstract.

### BACKGROUND OF THE INVENTION

1. Field of the Invention

The invention relates to a coupling that is provided in a vehicle and selectively transmits driving force from one power transmitting member to another power transmitting member. More particularly, the invention relates to reducing drag torque generated in that coupling.

2. Description of the Related Art

One known vehicle coupling is arranged between a driving member and a driven member in a vehicle, and has a wet type multiple disc clutch for selectively connecting or disconnecting the driving member to or from the driven member. One example of such a vehicle coupling is the electronically controlled coupling 200 shown in FIG. 3. This electronically controlled coupling 200 is arranged between a propeller shaft and a rear differential (i.e., a rear differential gear unit) of a vehicle, for example, and selectively connects or disconnects the propeller shaft to or from the rear differential, not shown. The electronically controlled coupling 200 includes, in a cylindrical front housing 202 that has a bottom and is connected to the propeller shaft, not shown, an inner shaft 204, a wet type multiple disc clutch 206, a main cam 208, a control clutch 212, a control cam 210, and an electromagnetic coil 216, and the like. The inner shaft 204 is arranged concentric with the front housing 202 and connected to a pinion gear of a rear differential, not shown. The main clutch 206 is used to selectively connect or disconnect the front housing 202 to or from the inner shaft 204. The main cam 208 functions as a piston that engages the main clutch 206 by pushing against it. The control clutch 212 is used to selectively connect or disconnect the front housing 202 to or from the control cam 210. The control cam 210 generates pressure in the axial direction of the front housing 202 or the inner shaft 204 on the main cam 208 via a ball 213 according to the engagement of the control clutch 212. The electromagnet coil 216 controls the engagement state of the control clutch 212 by generating magnetic flux to attract an armature 214 that is adjacent to the control clutch 212.

This electronically controlled coupling 200 is structured to generate even greater torque in the main clutch 206 by multiplying, via a cam mechanism (i.e., the control cam 210, the ball 213, and the main cam 208), the torque generated by the control clutch 212. For example, when current flows to the electromagnetic coil 216, magnetic flux is generated around the electromagnetic coil 216. This magnetic flux attracts the armature 214 to the control clutch 212 side such that the control clutch 212 engages. When the control clutch 212 engages, the front housing 202 becomes connected to the control cam 210, so a rotational difference occurs between the control cam 210 and the main cam 208. At this time, the ball 213 that is interposed between the control cam 210 and the main cam 208 pushes against the sloped surface formed therebetween, causing the main cam 208 to move to the main clutch 206 side and push against the main clutch 206. As a result, the main clutch 206 engages, so the front housing 202 becomes connected to the inner shaft 204. As described above, the torque generated by the control clutch 212 is multiplied by the cam mechanism, so torque that is several times the torque generated by the control clutch 212 is generated by the main clutch 206.

Also, when current is not flowing to the electromagnetic coil 216, torque is not generated in the control clutch 212, so the front housing 202 is disconnected from the inner shaft 204. However, even when current is not flowing to the electromagnetic coil 216, fluid gets in between the friction plates of the control clutch 212 as the front housing 202 is filled with lubricating oil (i.e., fluid). Therefore, when differential rotation occurs between the friction plates in the control clutch 212, torque is generated in the control clutch 212 by the viscosity resistance of that fluid. Accordingly, torque is also generated in the main clutch 206 as a result of the torque generated in the control clutch 212 being multiplied by the cam mechanism. Hereinafter in this specification, torque generated based on the viscosity resistance of the fluid in the control clutch 212 and the main clutch 206 will be referred to as drag torque.

When this drag torque is generated, torque is transmitted by this drag torque even if the electronically controlled coupling 200 is disconnected, so fuel efficiency may decrease. For example, if a four wheel drive vehicle is stuck in sand or the like and is unable to get out despite attempting to do so in four wheel drive, normally, inhibit control is executed and the vehicle is placed in front wheel drive by disconnecting the electronically controlled coupling 200 provided between the transfer and the rear wheels. At this time, the differential rotation between the front housing 202 and the inner shaft 204, i.e., the differential rotation between the friction plates of the control clutch 212, increases, so the drag torque of the control clutch 212 increases. As a result, the drag torque also increases in the main clutch 206, so fuel efficiency decreases. Also in a case in which a vehicle is being towed with two wheels on the ground, the drag torque increases as the differential rotation between the friction plates of the control clutch 212 and the main clutch 206 increases. As a result, the amount of heat generated between the friction plates increases, which may reduce the durability of the electronically controlled coupling 200.

Regarding this, Japanese Patent Application Publication No. 2002-13549 (JP-A-2002-13549) describes technology that attempts to reduce this drag torque in a coupling by providing fins on an axial side wall portion of a clutch housing that also serves as a pushing member, and generating reaction force in a direction that releases the clutch in the clutch housing by fluid striking the fins when the clutch housing rotates.

However, because the coupling described in JP-A-2002-13549 uses the reaction force generated by the fluid striking the fins, it becomes difficult to generate sufficient reaction force for only reducing the drag torque when differential rotation such as that described above becomes large, in particular, so in this case, fuel efficiency may decrease as drag torque is generated. Also, fuel efficiency may also decrease due to the rotational resistance from the fins.

### SUMMARY OF INVENTION

This invention provides a vehicle coupling that is capable of suitably suppressing drag torque that is large in proportion to the differential rotation between friction plates in the coupling, and suppressing a decrease in fuel efficiency and a decrease in durability, in a coupling that is arranged between a driving member and a driven member and has a wet type multiple disc clutch that selectively connects or disconnects the driving member to or from the driven member.

A first aspect of the invention relates to a vehicle coupling. This vehicle coupling includes a wet type multiple disc clutch that selectively connects or disconnects a driving member to or from a driven member; a piston that engages the wet type multiple disc clutch by pushing against the wet type multiple disc clutch in an axial direction; a pushing mechanism that generates force with which the piston pushes against the wet type multiple disc clutch, based on the relative torque between the driving member and the driven member; and a hydraulic mechanism that generates hydraulic pressure for generating thrust to move the piston away from the wet type multiple disc clutch, according to differential rotation between the driving member and the driven member when the wet type multiple disc clutch is released.

According to this vehicle coupling, a hydraulic mechanism is provided that generates hydraulic pressure for producing thrust in a direction that moves the piston away from the wet type multiple disc clutch according to the differential rotation between the driving member and the driven member. As a result, as thrust in the direction that moves the piston away from the wet type multiple disc clutch is produced according to that differential rotation against the drag torque generated based on the relative torque between the driving member and the driven member, that drag torque is able to be suppressed. Accordingly, a decrease in fuel efficiency that occurs with an increase in drag torque, as well as a decrease in durability due to an increase in the amount of heat generated in the wet type multiple disc clutch, can be suppressed.

Also, in the vehicle coupling described above, the hydraulic mechanism may include an oil pump provided such that the amount of fluid discharged therefrom increases according to the differential rotation. The hydraulic pressure generated by the oil pump may be supplied to a fluid chamber that is formed next to the piston and applies thrust to the piston so as to move the piston away from the wet type multiple disc clutch.

According to this vehicle coupling, the hydraulic pressure of the oil pump provided to increase the amount of fluid discharged according to the differential rotation between the driving member and the driven member is supplied to the fluid chamber. Therefore, the amount of fluid supplied to the fluid chamber increases, and thus the thrust that acts to move the piston away from the wet type multiple disc clutch increases, as the differential rotation increases. As a result, drag torque that increases as the differential rotation increases is able to be well suppressed by having thrust that corresponds to that drag torque act on the piston against that drag torque.

In the vehicle coupling described above, the oil pump may be a trochoid oil pump, and a driven rotor of the oil pump may be connected to the driving member and a drive rotor of the oil pump may be connected to the driven member.

Further, according to this vehicle coupling, the oil pump is a trochoid oil pump in which the driven rotor of this oil pump is connected to the driving member and the drive rotor of the oil pump is connected to the driven member. Therefore, if differential rotation occurs between the driving member and the driven member, the piston is able to be pushed by a force proportionate to the amount of that differential rotation. Also, the oil pump has a relatively simple structure, so the vehicle coupling is able to be made compact.

In the vehicle coupling described above, the vehicle coupling may be an electronically controlled coupling configured such that torque generated in a direction rotating about the axis by a control clutch that is electrically controlled is converted to torque in the axial direction and multiplied via a cam mechanism, and pushes against a main clutch. The main clutch may be the wet type multiple disc clutch described above. The driving member may be a cylindrical front housing that has a bottom. The driven member may be an inner shaft that is concentrically engaged with an inner peripheral side of the front housing. The main clutch and the piston for pushing against the main clutch may be arranged next to one another in the axial direction between the inner peripheral surface of the front housing and an outer peripheral surface of the inner shaft. The oil pump may be arranged housed in a bottom portion of the front housing. The driven rotor may be engaged with a receiving hole formed in the bottom portion of the front housing so as to be unable to rotate relative to the receiving hole. The drive rotor may be engaged with the outer peripheral surface of the inner shaft so as to be unable to rotate relative to the inner shaft. The oil pump may draw in and discharge fluid filled in the front housing. The Hydraulic pressure discharged from the oil pump may be supplied to the fluid chamber via a fluid passage formed inside the inner shaft.

According to this vehicle coupling, if differential rotation occurs between the front housing, i.e., the driving member, and the inner shaft, i.e., the driven member, drag torque proportionate to that differential rotation is generated in the control clutch by the viscosity resistance of the fluid. Also, that drag torque is transmitted to the piston via the cam mechanism and the piston pushes on the main clutch, so drag torque is generated in the main clutch as well. The drag torque that is generated in this main clutch is large in proportion to the drag torque that is generated in the control clutch, i.e., in proportion to that differential rotation. At the same time, hydraulic pressure of the oil pump in which the discharge pressure is large in proportion to the differential rotation is supplied to the fluid chamber formed next to the piston, such that thrust that acts to move the piston away from the main clutch is produced. Therefore, the piston is pushed, against the drag torque of the main clutch that is large in proportion to the differential rotation, away from the main clutch by a force proportionate to that drag force, so that drag torque is able to be effectively suppressed.

Here, preferably the vehicle coupling is sufficiently filled with fluid, and the oil pump draws in and discharges that fluid. Accordingly, there is no need to supply fluid from outside the vehicle coupling, so the structure can be simplified.

### BRIEF DESCRIPTION OF DRAWINGS

The features, advantages, and technical and industrial significance of this invention will be described in the following detailed description of example embodiments of the invention with reference to the accompanying drawings, in which like numerals denote like elements, and wherein:

FIG. 1 is a skeleton view of the structure of a front and rear wheel drive vehicle that is based on front engine-front wheel drive (FF) and has a driving force transmitting apparatus to which the invention may be suitably applied;

FIG. 2 is a sectional view of the structure of an electronically controlled coupling shown in FIG. 1; and

FIG. 3 is a sectional view of the structure of an electronically controlled coupling according to related art.

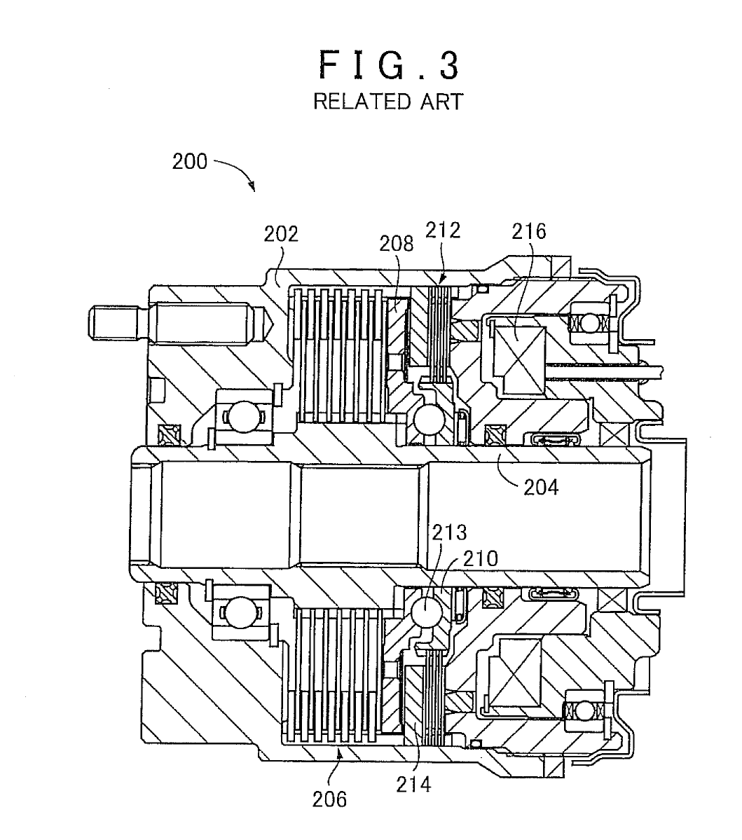

### DETAILED DESCRIPTION OF EMBODIMENTS

Hereinafter, example embodiments of the invention will be described in detail with reference to the accompanying drawings. Incidentally, the drawings described in the example embodiments below have been simplified or modified as appropriate, so the scale ratios and the shapes and the like of the portions are not always accurately depicted.

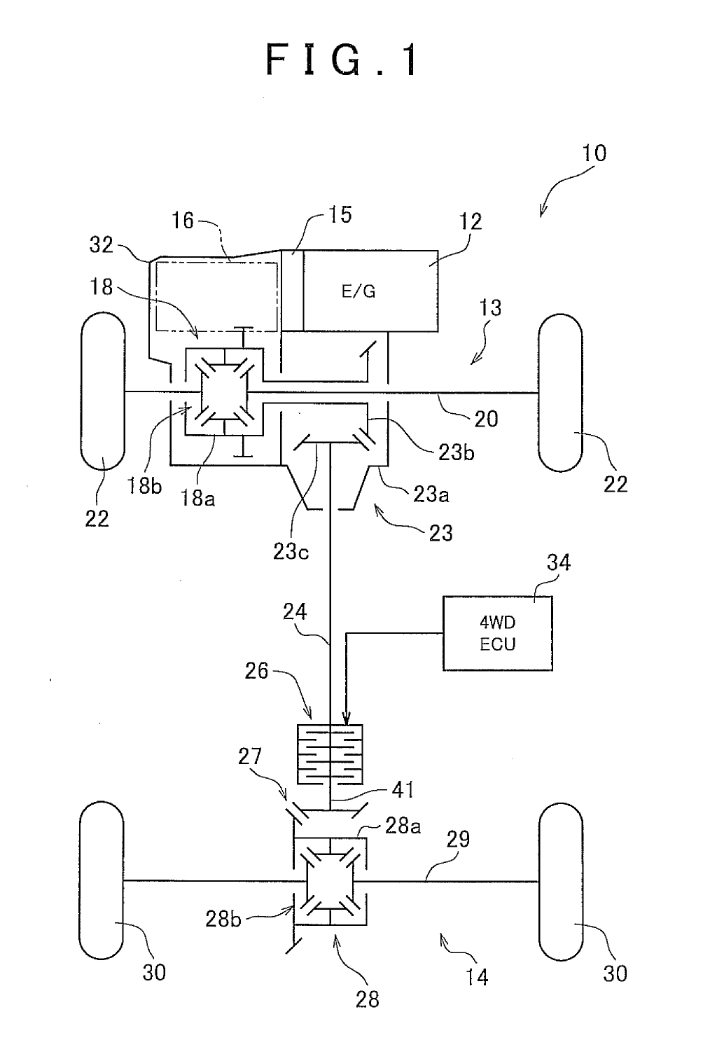

FIG. 1 is a skeleton view of the structure of a front and rear wheel drive vehicle that is based on front engine-front wheel drive (FF) and has a vehicular power transmitting apparatus 10 (hereinafter simply referred to as “power transmitting apparatus 10”) to which the invention may be suitably applied. In FIG. 1, an engine 12 is an internal combustion engine such as a gasoline engine or a diesel engine or the like, and is a driving source that generates driving force by combusting fuel. The power transmitting apparatus 10 according to this example embodiment includes a first power transmitting path 13 that transmits power from the engine 12 to front wheels 22, a second power transmitting path 14 that transmits power from the engine 12 to rear wheels 30, and a vehicular electronically controlled coupling 26 (hereinafter, simply referred to as “electronically controlled coupling 26”) that is a front and rear wheel driving force distributing apparatus interposed in the second power transmitting path 14. The first power transmitting path 13 runs from the engine 12 to the pair of left and right front wheels 22 via a front differential gear unit 18 and a pair of left and right front axles 20 that are rotatably driven by the engine 12 via a torque converter 15 and a transmission 16. Also, the second power transmitting path 14 runs from the engine 12 to the pair of right and left rear wheels 30 via a differential case 18a of the front differential gear unit 18, a transfer 23, a propeller shaft 24, the electronically controlled coupling 26 that serves as the front and rear wheel driving force distributing apparatus, a reduction gear 27, a rear differential gear unit 28, and a pair of left and right rear axles 29. Further, an electronic control unit (ECU) 34 for controlling the electronically controlled coupling 26 is provided in the power transmitting apparatus 10. That is, the power transmitting apparatus 10 is an example of a drive system of an electronically controlled torque split four wheel drive vehicle in which torque generated by the engine 12 that serves as the power source is distributed between the front and rear wheels according to the running state.

The torque converter 15 is a fluid power transmitting device that includes a pump impeller that is connected to a crankshaft of the engine 12, a turbine runner that is connected to an input shaft of the transmission 16, and a stator that is fixed to a transmission case via a one-way clutch, and transmits power between the pump impeller and the turbine runner via fluid.

The transmission 16 is, for example, an automatic transmission that includes a plurality of friction engagement elements, and selectively establishes a plurality of speeds according to the combination in which those friction engagement elements are applied or released. This transmission 16 inputs rotation, changes the rate of that rotation according to the speed ratio γ that corresponds to the established speed, and then outputs the rotation of the changed rate.

The front differential gear unit 18 is a so-called bevel type differential gear unit that is provided with a differential case 18a that is rotatably supported, and differential gears 18b provided inside that differential case 18a. The differential gears 18b include a pair of side gears that oppose one another on the axis of the differential case 18a, a pinion shaft provided in the differential case 18a between the pair of side gears and perpendicular to the axis, and a pair of pinion gears that are rotatably supported by the pinion shaft and in mesh with the pair of side gears. Similarly, the rear differential gear unit 28 is a so-called bevel type differential gear unit that is provided with a differential case 28a that is rotatably supported, and differential gears 28b provided inside that differential case 28a. The differential gears 28b include a pair of side gears that oppose one another on the axis of the differential case 28a, a pinion shaft provided in the differential case 28a between the pair of side gears and perpendicular to the axis, and a pair of pinion gears that are rotatably supported by the pinion shaft and in mesh with the pair of side gears. The pair of front axles 20 are integrally connected to the pair of side gears of the differential gears 18b, and the pair of rear axles 29 are integrally connected to the pair of side gears of the differential gears 28b. The front differential gear unit 18 structured in this way rotatably drives the pair of front axles 20 while allowing a difference in rotation speeds of the pair of front axles 20, and the rear differential gear unit 28 structured in this way rotatably drives the pair of rear axles 29 while allowing a difference in rotation speeds of the pair of rear axles 29. Incidentally, the front differential gear unit 18 is arranged inside a transaxle case 32 that is shared by the transmission 16, and includes a transverse mounted transaxle.

The transfer 23 includes a bevel gear type transfer drive gear 23b that is rotatably supported by a transfer case 23a, and a bevel gear type transfer driven gear 23c that is in mesh with the transfer drive gear 23b such that power can be transmitted therebetween. This transfer 23 is designed to change the direction in which rotation is transmitted between the differential case 18a and the propeller shaft 24 to a substantially 90 degree angle.

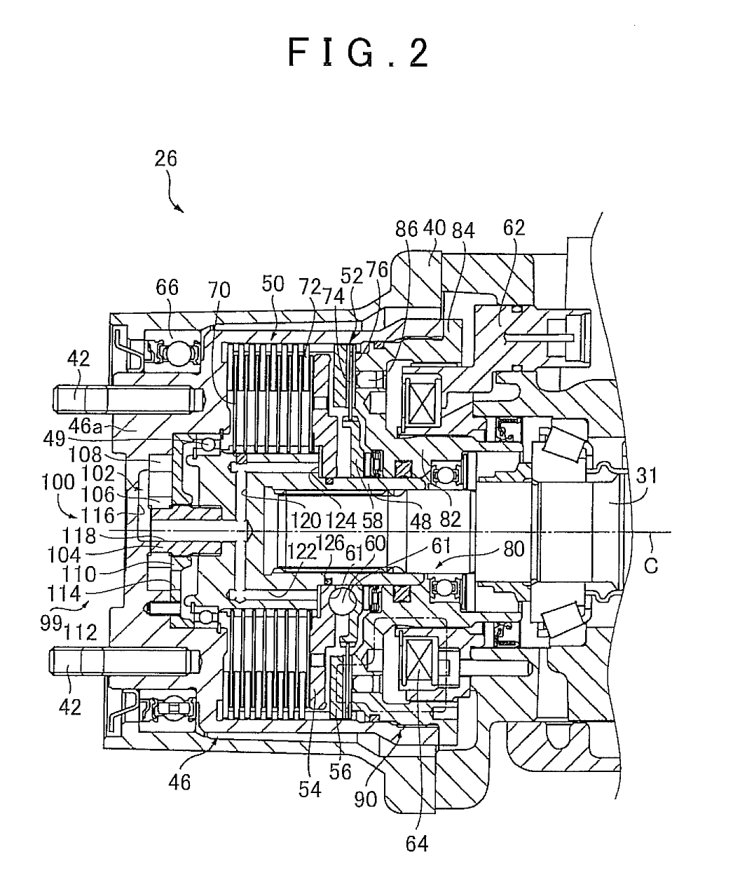

FIG. 2 is a sectional view of the structure of the electronically controlled coupling 26 (that may be regarded as the vehicle coupling of the invention) shown in FIG. 1. The electronically controlled coupling 26 is interposed between the propeller shaft 24 (not shown in FIG. 2) that is rotatably arranged on a common axis C and a drive pinion 31 of the reduction gear 27, and appropriately connects or disconnects the propeller shaft 24 to or from the drive pinion 31. The electronically controlled coupling 26 includes, in a cylindrical case 40 that is a non-rotating member, a cylindrical front housing 46 (that may be regarded as the driving member of the invention), a cylindrical inner shaft 48 (that may be regarded as the driven member of the invention), a main clutch 50 (that may be regarded as the wet type multiple disc clutch of the invention) and a control clutch 52, a main cam 54, an armature 56, a control cam 58, a ball 60, and an electromagnetic coil 64. The front housing 46 has a bottom and rotates together with the propeller shaft 24 by being connected to the propeller shaft 24 by bolts 42. The inner shaft 48 has a bottom and is spline-engaged with the end portion of the drive pinion 31 of the reduction gear 27 so as to rotate together with the drive pinion 31. The main clutch 50 and the control clutch 52 are arranged between the inner peripheral surface of the front housing 46 and the outer peripheral surface of the inner shaft 48. The main cam 54 is adjacent to the main clutch 50 and engages the main clutch 50 by pushing against it appropriately in the axial direction. The armature 56 is adjacent to the control clutch 52 and engages the control clutch 52 by pushing against it appropriately in the axial direction. The control cam 58 is connected to the front housing 46 when the control clutch 52 is engaged. The ball 60 is interposed between the main cam 54 and the control cam 58. The electromagnetic coil 64 is arranged on the reduction gear 27 side (i.e., on the right side in FIG. 2) in the axial direction with respect to the control clutch 52, and retained by a coil retainer 62 that is a non-rotating member that will be described later.

The cylindrical front housing 46 with a bottom is rotatably supported by the cylindrical case 40 that is a non-rotating member about the axis C via a bearing 66 that has a seal function. A bottom portion 46a of the front housing 46 is connected to an end portion of the propeller shaft 24 by the bolts 42, and thus rotates together with the propeller shaft 24. The cylindrical inner shaft 48 with a bottom has a diameter that is sufficiently smaller than that of the front housing 46, and is arranged so as to be able to rotate about the axis C while fitted inside the front housing 46. The front housing 46 and the inner shaft 48 are supported so as to be able to rotate relative to one another via a bearing 49. Incidentally, the front housing 46 preferably forms a magnetic circuit by an electromagnet 90 that will be described later, and is thus formed from nonmagnetic material such as a light alloy.

The main clutch 50 and the control clutch 52 for selectively connecting or disconnecting the front housing 46 to or from the inner shaft 48 are lined up in the axial direction in a space formed between the inner peripheral surface of the front housing 46 and the outer peripheral surface of the inner shaft 48.

The main clutch 50 is a wet type multiple disc clutch and includes a plurality of disc-shaped inner peripheral side friction plates 70 on the inner peripheral portion and a plurality of disc-shaped outer peripheral side friction plates 72 on the outer peripheral portion. The inner peripheral side friction plates 70 are engaged with the outer peripheral surface of the inner shaft 48 so as to be unable to rotate relative to the inner shaft 48 but able to move in the axial direction of the inner shaft 48. The outer peripheral side friction plates 72 are engaged with the inner peripheral surface of the front housing 46 so as to be unable to rotate relative to the front housing 46 but able to move in the axial direction of the front housing 46. The friction plates 70 and the friction plates 72 are stacked alternately.

The main cam 54 that is adjacent in the axial direction to the main clutch 50 is a disc-shaped member that has a predetermined thickness and rotates together with the inner shaft 48 by being engaged with the outer peripheral surface of the inner shaft 48 so as to be unable to rotate relative to the inner shaft 48 but able to move in the axial direction of the inner shaft 48. When the main cam 54 moves to the main clutch 50 side, the main cam 54 pushes against the main clutch 50 such that the main clutch 50 engages and the front housing 46 and the inner shaft 48 become connected as a result. Incidentally, the main cam 54 may be regarded as the piston of the invention.

Also, the control clutch 52 includes a disc-shaped inner peripheral side friction plate 74 on the inner peripheral portion and disc-shaped outer peripheral side friction plates 76 on the outer peripheral portion. The inner peripheral side friction plate 74 is engaged with the outer peripheral surface of the control cam 58 so as to be unable to rotate relative to the control cam 58 but able to move in the axial direction of the control cam 58. The outer peripheral side friction plates 76 are engaged with the inner peripheral surface of the front housing 46 so as to be unable to rotate relative to the front housing 46 but able to move in the axial direction of the front housing 46. The friction plate 74 and the friction plates 76 are stacked alternately.

The outer peripheral portion of the magnetic metal armature 56 that is adjacent to the control clutch 52 is engaged with the inner peripheral surface of the front housing 46 such that the armature 56 is unable to rotate relative to the front housing 46 but able to move in the axial direction of the front housing 46. When the armature 56 is moved to the control clutch 52 side, the armature 56 pushes against the control clutch 52, causing the control clutch 52 to engage such that the front housing 46 and the control cam 58 become connected. Here, this armature 56 is attracted to the control clutch 52 side by magnetic flux generated by excitation current flowing into an electromagnetic coil 64, as will be described later. Incidentally, the excitation current of the electromagnetic coil 64 is appropriately controlled by the ECU 34. The pressure with which the armature 56 pushes against the control clutch 52 changes according to that excitation current.

The control cam 58 is formed in an annular shape and the inner peripheral end of the control cam 58 is slidably engaged with the inner shaft 48. When the control clutch 52 is engaged, the control cam 58 is connected to the front housing 46 and thus rotates together with the front housing 46. When the control cam 58 rotates, differential rotation occurs between the control cam 58 and the main cam 54, so the ball 60 that is interposed between the control cam 58 and the main cam 54 rolls in the circumferential direction.

A plurality of the balls 60 are interposed at equiangular intervals in the circumferential direction (i.e., in the direction rotating about the axis) of the main cam 54 or the control cam 58 between the main cam 54 and the control cam 58, and housed in grooves 61 formed in the main cam 54 and the control cam 58. A plurality of these grooves 61 are formed in the circumferential direction, one for each of the balls 60. These grooves 61 are formed with sloped faces such that they become shallower in the circumferential direction farther away from a predetermined position at which they are deepest. Therefore, when the balls 60 roll in the circumferential direction, they move along the sloped faces formed in the grooves 61, so the main cam 54 is moved to the main clutch 50 side by the balls 60. As a result, the main cam 54 pushes against the main clutch 50 such that the main clutch 50 engages. Also, the main cam 54, the control cam 58, and the balls 60 function as a cam mechanism. As a result, torque several times the torque generated by the control clutch 52 is transmitted to the main clutch 50 by the main cam 54 being moved in the axial direction via that cam mechanism based on the torque in the circumferential direction that is generated by the control clutch 52, and pushing against the main clutch 50.

A cover member 80 is arranged between the control clutch 52 and the electromagnetic coil 64 so as to cover the opening of the front housing 46. This cover member 80 is formed in a double cylinder shape with a bottom, and is integrally formed from three members, i.e., an inner peripheral side cover member 82 made of a magnetic metal such as silicon steel, an outer side peripheral cover member 84 made of a magnetic metal such as silicon steel, and a press-fit member 86 made of nonmagnetic stainless steel that is press-fit in between the inner peripheral side cover member 82 and the outer peripheral side cover member 84. A magnetic circuit indicated by the alternate long and short dash line in FIG. 2 is preferably formed by the press-fit member 86 made of nonmagnetic stainless steel. The outer peripheral surface of the outer peripheral side cover member 84 is spline-engaged with the inner peripheral surface of the front housing 46, so the cover member 80 rotates together with the front housing 46. Also, the electromagnetic coil 64 is housed in the space formed between the outer peripheral surface of the inner peripheral side cover member 82 and the inner peripheral surface of the outer peripheral side cover member 84.

The electromagnet 90 includes a cylindrical coil retainer 62 that is made of a magnetic metal such as silicon steel, and the annular electromagnetic coil 64 that is fixed to an end portion of that coil retainer 62. When excitation current flows to the electromagnetic coil 64 of the electromagnet 90 that is annular shaped, a magnetic flux is produced around the electromagnetic coil 64. The attraction force of this electromagnet 90 causes the armature 56 to be attracted to the control clutch 52 side, such that the control clutch 52 engages. The engagement state (i.e., the engaging torque) of the control clutch 52 is electrically controlled by the ECU 34 electrically controlling the excitation current that flows to the electromagnetic coil 64.

For example, if the excitation current that flows to the electromagnetic coil 64 is small, the force with which the armature 56 pushes against the control clutch 52 is small, so the engaging force and the transfer torque of the control clutch 52 are small. Therefore, the transfer torque of the main clutch 50 is also small, so the torque that is transmitted from the propeller shaft 24 to the drive pinion 31 of the reduction gear 27 is small. On the other hand, if the excitation current that flows to the electromagnetic coil 64 increases, the force with which the armature 56 pushes against the control clutch 52 increases, so the engaging force and the transfer torque of the control clutch 52 increases. Therefore, the transfer torque of the main clutch 50 also increases, so the torque that is transmitted from the propeller shaft 24 to the drive pinion 31 of the reduction gear 27 increases.

Incidentally, the electronically controlled coupling 26 is filled with oil (approximately up to the height of the axis C, for example), and then an oil-tight seal is provided by the bearing 66 or the like that has a seal function. As a result, fluid gets in between the friction plates of the main clutch 50 and the control clutch 52 (i.e., in between the inner peripheral side friction plates and the outer peripheral side friction plates). Therefore, even if current is not flowing to the electromagnetic coil 64, if there is differential rotation between the friction plates in the control clutch 52, torque proportionate to that differential rotation (hereinafter referred to as “drag torque”) is generated by the viscosity resistance of the fluid between those friction plates. Also, the drag torque generated by the control clutch 52 generates force with which the main cam 54 pushes against the main clutch 50 via the cam mechanism, so even greater drag torque is also generated in the main clutch 50. Here, if for example the vehicle becomes stuck and is unable to get out despite attempting to do so in four wheel drive, inhibit control is executed based on a predetermined condition (such as an increase in fluid temperature) and the vehicle is placed in two wheel drive. At this time, the drag torque increases as the differential rotation of the clutch (i.e., the friction plates) in the coupling increases, so fuel efficiency may decrease. Also, if for example a vehicle is being towed with two wheels on the ground (such as with only the rear wheels on the ground), the drag torque will increase as the differential rotation of the clutch (i.e., the friction plates) within the coupling increases, so the amount of heat generated in the clutch increases, which may reduce the durability of the coupling.

Therefore, drag torque is suppressed by providing the electronically controlled coupling 26 in this example embodiment with a hydraulic mechanism 99 that generates hydraulic pressure for producing thrust to push the main cam 54 in the direction that inhibits engagement of the main clutch 50 in proportion to the amount of differential rotation between the friction plates of the main clutch 50 and the control clutch 52. This hydraulic mechanism 99 that suppresses drag torque will now be described.

The force that pushes the main cam 54 is generated by hydraulic pressure, and that hydraulic pressure is generated by an oil pump 100 provided inside the electronically controlled coupling 26. The oil pump 100 is formed by a so-called trochoid oil pump and is arranged housed in a disc-shaped receiving hole 102 that has a relatively large diameter and is formed in the bottom portion 46a of the front housing 46.

The oil pump 100 includes a cylindrical shaft 104, a drive rotor 106, a driven rotor 108, and a pump cover 110. The shaft 104 is arranged on the axis C of the inner shaft 48 and is connected to the inner shaft 48 so as to be unable to rotate relative to the inner shaft 48 by being spline-engaged at one end with the inner shaft 48. The drive rotor 106 is engaged with the outer peripheral surface of the other end of the shaft 104 so as to be unable to rotate relative to the shaft 104. The driven rotor 108 is in mesh with the drive rotor 106 while being engaged with the outer peripheral surface of the receiving hole 102 of the front housing 46 so as to be unable to rotate relative to the receiving hole 102. The pump housing 110 encapsulates the drive rotor 106 and the driven rotor 108 that are housed in the receiving hole 102 while providing an oil-tight seal. Incidentally, the shaft 104 may be regarded as the power transmitting shaft of the invention that is provided for the inner shaft and integrally coupled with an end portion of the inner shaft.

The inner peripheral portion of the drive rotor 106 is engaged by press-fitting or a key or the like with the shaft 104 that rotates together with the inner shaft 48, such that the drive rotor 106 rotates together with the shaft 104, and as a result, the drive rotor 106 rotates together with the inner shaft 48 about the axis C. Outer peripheral teeth formed on the outer peripheral side of this drive rotor 106 are in mesh with inner peripheral teeth formed on the inner peripheral side of the driven rotor 108. The outer peripheral portion of the driven rotor 108 is engaged by press-fitting or the like with the inner peripheral end of the receiving hole 102 formed in the front housing 46, such that the driven rotor 108 is unable to rotate relative to the receiving hole 102, and thus rotates together with the front housing 46.

The pump cover 110 is fixed to the front housing 46 by a plurality of bolts 112 provided in the circumferential direction, and the inner peripheral surface of the pump cover 110 slides on the shaft 104. Also, an oil inlet 114 for supplying fluid to the oil pump 100 is formed in the pump cover 110. Fluid filled in the electronically controlled coupling 26 (i.e., in the front housing 46) is drawn into the oil pump 100 through this oil inlet 114 as the oil pump 100 is driven.

The oil that is drawn in through the oil inlet 114 enters a gap formed between the drive rotor 106 and the driven rotor 108, and is then compressed and discharged to an oil discharge passage 116. The fluid that has been discharged to this oil discharge passage 116 is supplied to an axial oil passage 118 (that may be regarded as the oil passage of the invention) formed inside the shaft 104.

One end in the axial direction of the axial oil passage 118 is communicated with the oil discharge passage 116, while the other end is communicated with a first oil passage 120 that is formed inside the inner shaft 48 and extends in the radial direction from the center portion. In this example embodiment, two of these first oil passages 120 are formed diagonally in a square (i,e., intersecting each other), and the end portion on the radial outside of each first fluid passage 120 is communicated with one end of a corresponding second oil passage 122 formed parallel with the axis C. Furthermore, the other end of each second oil passage 122 is communicated with an annular fluid chamber 124 formed adjacent to the main cam 54 by being surrounded by a stepped portion of the inner shaft 48 and the main cam 54. Here, an oil seal 126 is provided at the sliding portion (i.e., the gap) between the inner peripheral surface of the main cam 54 and the outer peripheral surface of the inner shaft 48. Fluid is inhibited from leaking out of the fluid chamber 124 by designing the gap so that it is small at the spline engaging portion between the main cam 54 and the inner shaft 48. Incidentally, the first fluid passages 120 and the second fluid passages 122 may be regarded as the fluid passages of the invention.

When hydraulic pressure is supplied to the fluid chamber 124, that hydraulic pressure applies thrust to the main cam 54 in order to push the main cam 54 in the axial direction away from the main clutch 50. Accordingly, when the fluid discharged from oil pump 100 is supplied to the fluid chamber 124 via the oil discharge passage 116, the axial fluid passage 118 of the shaft 104, and the first fluid passages 120 and second fluid passages 122 of the inner shaft 48, the main cam 54 is pushed away from the main clutch 50. Also, the amount of fluid discharged from the oil pump 100 increases, and thus the amount of fluid supplied to the fluid chamber 124 increases, according to (i.e., in proportion to) the differential rotation between the drive rotor 106 and the driven rotor 108, i.e., the differential rotation between the front housing 46 and the inner shaft 48, so the pressure applied to the main cam 54 increases. Incidentally, the hydraulic mechanism 99 of the invention includes the oil pump 100, the oil discharge passage 116, the axial fluid passage 118, the first fluid passages 120, the second fluid passages 122, and the fluid chamber 124 and the like.

Next, the operation of the electronically controlled coupling 26 structured as described above will be described. For example, if a vehicle is being towed with the rear wheels 30 on the ground and the front wheels 22 lifted off of the ground, the front wheels 22 stop rotating, while the rear wheels 30 are rotated. At this time, because the front wheels 22 stop rotating, the propeller shaft 24 and the front housing 46 that is connected to the propeller shaft 24 also stop rotating. Meanwhile, as the rear wheels 30 rotate, the drive pinion 31 of the reduction gear 27 that is connected to the rear wheels 30 such that power can be transmitted therebetween, and the inner shaft 48 that is spline-engaged with the drive pinion 31, are rotated. At this time, differential rotation occurs in the outer peripheral side friction plates 76 that are spline-engaged with the front housing 46 and the inner peripheral side friction plate 74 that is spline-engaged with the control cam 58, which together form the control clutch 52, so drag torque from the viscosity resistance of the fluid in between the outer peripheral side friction plates 76 and the inner peripheral side friction plate 74 is generated. Also, this drag torque causes the main cam 54 to push against the main clutch 50 via the cam mechanism, so drag torque is also generated in the main clutch 50.

At the same time, the drive rotor 106 that rotates together with the inner shaft 48 is made to rotate, so the oil pump 100 is driven, and as a result, fluid that is drawn in through the oil inlet 114 is compressed and discharged from the oil discharge passage 116, and supplied to the fluid chamber 124 via the axial fluid passage 118, the first fluid passages 120, and the second fluid passages 122. The hydraulic pressure supplied to this fluid chamber 124 pushes the main cam 54 toward the control cam 58, i.e., away from the main clutch 50. As a result, the drag torque generated in the main clutch 50 is reduced as the force with which the main cam 54 pushes against the main clutch 50 is suppressed. Also, abnormal noise from the drag torque generated at the main clutch 50 is also suppressed.

Here, if the differential rotation between the front housing 46 and the inner shaft 48 increases, the differential rotation between the inner peripheral side friction plate 74 and the outer peripheral side friction plates 76 of the control clutch 52 described above also increases, and as a result, the drag torque of the control clutch 52 and the drag torque of the main clutch 50 increase. However, the force (i.e., the pressure) that pushes the main cam 54 away from the main clutch 50 similarly increases in proportion to the amount of differential rotation between the front housing 46 and the inner shaft 48, so the drag torque generated in the main clutch 50 is well suppressed. On the other hand, if the differential rotation between the front housing 46 and the inner shaft 48 decreases, the drag torque from the viscosity resistance of the fluid decreases and the amount of fluid discharged from the oil pump 100 also decreases, so the pressure that pushes the main cam 54 away from the main clutch 50 decreases as well.

Also, for example, if the vehicle is stuck in sand or the like and is unable to get out despite attempting to do so in four wheel drive, inhibit control is executed based on the increase in fluid temperature and the like and the vehicle is switched to front wheel drive. In this case, only the front wheels 22 are driven and the rear wheels 30 stop rotating, so the differential rotation between the front housing 46 and the inner shaft 48 increases, and as it does, the drag torque also increases, thus reducing fuel efficiency. With regard to this as well, the differential rotation between the drive rotor 106 and the driven rotor 108 of the oil pump 100 increases so the amount of fluid discharge from the oil pump 100 increases. Accordingly, the pressure applied in the direction that moves the main cam 54 away from the main clutch 50 increases, such that the drag torque at the main clutch 50 is reduced.

As described above, according to this example embodiment, the hydraulic mechanism 99 is provided that generates hydraulic pressure for producing thrust in a direction that moves the main cam 54 away from the main clutch 50 according to the differential rotation between the front housing 46 and the inner shaft 48. As a result, as thrust in the direction that moves the main cam 54 away from the main clutch 50 is produced according to that differential rotation against the drag torque that is generated based on the relative torque between the front housing 46 and the inner shaft 48, that drag torque is able to be effectively suppressed. Accordingly, a decrease in fuel efficiency that occurs with an increase in drag torque, as well as a decrease in durability due to an increase in the amount of heat generated in the main clutch 50, can be suppressed.

Also, according to this example embodiment, the hydraulic pressure of the oil pump 100 provided to increase the amount of fluid discharged according to the differential rotation between the front housing 46 and the inner shaft 48 is supplied to the fluid chamber 124. Therefore, the amount of fluid supplied to the fluid chamber 124 increases, and thus the thrust that acts to move the main cam 54 away from the main clutch 50 increases, as the differential rotation increases. Thus, drag torque that increases as the differential rotation increases is able to be well suppressed by having thrust that corresponds to that drag torque act on the main cam 54 against that drag torque.

Further, according to this example embodiment, the oil pump 100 is a trochoid oil pump in which the driven rotor 108 of this oil pump 100 is connected to the front housing 46 and the drive rotor 106 of the oil pump 100 is connected to the inner shaft 48. Therefore, if differential rotation occurs between the front housing 46 and the inner shaft 48, the main cam 54 is able to be pushed by a force proportionate to the amount of that differential rotation. Also, the oil pump 100 has a relatively simple structure, so the electronically controlled coupling 26 is able to be made compact.

Moreover, according to this example embodiment, if differential rotation occurs between the front housing 46 and the inner shaft 48, drag torque proportionate to that differential rotation is generated in the control clutch 52 by the viscosity resistance of the fluid. Also, that drag torque is transmitted to the main cam 54 via the cam mechanism and the main cam 54 pushes on the main clutch 50, so drag torque is generated in the main clutch 50 as well. The drag torque that is generated in this main clutch 50 is large in proportion to the drag torque that is generated in the control clutch 52, i.e., in proportion to that differential rotation. At the same time, hydraulic pressure of the oil pump 100 in which the discharge pressure is large in proportion to the differential rotation is supplied to the fluid chamber 124 formed next to the main cam 54, such that thrust that acts to move the main cam 54 away from the main clutch 50 is produced. Therefore, the main cam 54 is pushed, against the drag torque of the main clutch 50 that is large in proportion to the differential rotation, away from the main clutch 50 by a force proportionate to that drag force, so that drag torque is able to be effectively suppressed.

Heretofore, example embodiments of the invention have been described in detail with reference to the accompanying drawings. However, the invention may also be applied in other modes.

For example, in the example embodiment described above, the trochoid oil pump 100 is used, but the invention is not limited to a trochoid oil pump. For example, another type of oil pump, such as a vane oil pump, may also be used.

Further, in the example embodiment described above, the electronically controlled coupling 26 is provided between the propeller shaft 24 and the reduction gear 27, but the invention is not limited to this arrangement. That is, any suitable arrangement may be used as long as the electronically controlled coupling 26 is in a position that enables it to selectively connect or disconnect the driving member to or from the driven member, such as between a power transmitting shaft that transmits power to the front wheels and a front differential gear unit, for example.

Moreover, in the example embodiment described above, the invention is applied to a front and rear wheel drive vehicle that is based on front engine-front wheel drive (FF). However, the invention may also be applied to a vehicle having another configuration, such as a front and rear wheel drive vehicle that is based on front engine-rear wheel drive (FR).

Further, with the example embodiment described above, the driven rotor 108 is engaged with the front housing 46 and the drive rotor 106 is engaged with the inner shaft 48 (i.e., the shaft 104). Alternatively, however, the drive rotor 106 may be engaged with the front housing 46, and the driven rotor 108 may be engaged with the inner shaft 48.

Incidentally, the example embodiments described above are merely examples. That is, the invention may be carried out in modes that have been modified or improved in any of a variety of ways based on the knowledge of one skilled in the art.

What is claimed is:

1. A vehicle coupling comprising:
a wet type multiple disc clutch that selectively connects or disconnects a driving member to or from a driven member;
a piston that engages the wet type multiple disc clutch by pushing against the wet type multiple disc clutch in an axial direction;
a pushing mechanism that generates force with which the piston pushes against the wet type multiple disc clutch, based on the relative torque between the driving member and the driven member; and
a hydraulic mechanism that generates hydraulic pressure for generating thrust to move the piston away from the wet type multiple disc clutch, according to differential rotation between the driving member and the driven member when the wet type multiple disc clutch is released.

2. The vehicle coupling according to claim 1, wherein the pushing mechanism is a cam mechanism.

3. The vehicle coupling according to claim 1, wherein the axial direction is the axial direction of the driving member or the driven member.

4. The vehicle coupling according to claim 1, wherein the hydraulic mechanism includes an oil pump provided such that the amount of fluid discharged therefrom increases according to the differential rotation; and the hydraulic pressure generated by the oil pump is supplied to a fluid chamber that is formed next to the piston and applies thrust to the piston so as to move the piston away from the wet type multiple disc clutch.

5. The vehicle coupling according to claim 4, wherein the oil pump is structured such that the amount of fluid that is discharged increases as the differential rotation increases.

6. The vehicle coupling according to claim 4, wherein the oil pump is a trochoid oil pump; and a driven rotor of the oil pump is connected to the driving member and a drive rotor of the oil pump is connected to the driven member.

7. The vehicle coupling according to claim 6, wherein the vehicle coupling is an electronically controlled coupling configured such that torque generated in a direction rotating about the axis by a control clutch that is electrically controlled is converted to torque in the axial direction and multiplied via a cam mechanism, and pushes against a main clutch; the main clutch is the wet type multiple disc clutch; the driving member is a cylindrical front housing that has a bottom; the driven member is an inner shaft that is concentrically engaged with an inner peripheral side of the front housing; the main clutch and the piston for pushing against the main clutch are arranged next to one another in the axial direction between the inner peripheral surface of the front housing and an outer peripheral surface of the inner shaft; the oil pump is arranged housed in a bottom portion of the front housing; the driven rotor is engaged with a receiving hole formed in the bottom portion of the front housing so as to be unable to rotate relative to the receiving hole; the drive rotor is engaged with the outer peripheral surface of the inner shaft so as to be unable to rotate relative to the inner shaft; the oil pump draws in and discharges fluid filled in the front housing; and hydraulic pressure discharged from the oil pump is supplied to the fluid chamber via a fluid passage formed inside the inner shaft.

8. The vehicle coupling according to claim 7, wherein the inner shaft includes a power transmitting shaft that is integrally coupled to an end portion of the inner shaft; the drive rotor is engaged to an outer peripheral surface of the power transmitting shaft so as to be unable to rotate relative to the power transmitting shaft; and the fluid passage is formed inside of the inner shaft and the inside of the power transmitting shaft and communicates the inside of the inner shaft with the inside of the power transmitting shaft.
